(19) United States
(12) Patent Application Publication
(10) Pub. No.: US 2011/0024483 A1
(43) Pub. Date: Feb. 3, 2011

(54) METHOD OF ASSEMBLING GOLD ALLOY PARTS

(75) Inventor: Jérôme Pech, Sapois (FR)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: DANIEL ROTH & GERALD GENTA HAUTE HORLOGERIE S.A., Meyrin (CH)

(21) Appl. No.: 12/847,086

(22) Filed: Jul. 30, 2010

(30) Foreign Application Priority Data
Jul. 31, 2009 (CH) 01200/09

(51) Int. Cl. B23K 1/20; B23K 31/02; B23K 31/10

(52) U.S. Cl. 228/176; 228/208; 228/178

(57) ABSTRACT

The invention relates to a method of assembling gold alloy parts that enables identical or different gold alloys, particularly gold alloys of different colors, to be assembled.

This method comprises the following steps:
a) a film of tin is applied over at least one portion of a face of a first gold alloy part;
b) the tinned face of the first gold alloy part is brought directly into contact with a face of a second gold alloy part;
c) the first and second parts are pressed against each other; and
d) the assembly is heated.

This method may be used to manufacture checkerboards.

The invention relates to a method of assembling gold alloy parts which serves to assemble identical or different gold alloys, in particular gold alloys of different colors.

### BACKGROUND OF THE INVENTION

The authors of the article entitled “Diffusion Soldering—A New Low Temperature Process For Joining Carat Gold Jewellery” published in Gold Bull., 1993, 26(3), pages 90 to 104, were interested in the diffusion bonding of gold alloys. However, their study is limited to joining gold alloys of the same color, and the authors focused on finding the best operating conditions, that is to say those making it possible, in particular, to obtain a joint that cannot be distinguished by the naked eye from the gold alloy zones that are contiguous therewith.

These operating conditions are summarized in the annex appearing at the end of the above article, and are essentially:
an annealed gold foil 75 microns in thickness covered on each side with 3 to 4 microns of tin by electroplating is used;
the tin-coated gold foil is placed between the gold alloy parts to be joined together;
the assembly is heated to 435 or 500° C.;
the parts are pressed against each other typically under a force of 1 MPa for 30 seconds; and
the product obtained then undergoes a homogenization operation at 450° C. for 1 hour.

### BRIEF DESCRIPTION OF THE INVENTION

The objective of the invention is to provide a method of assembling gold alloy parts that allows identical gold alloys or those of different compositions, in particular gold alloys of different colors, to be effectively assembled. This method must be simple, quick, easy to implement, inexpensive and able to be used in an industrial process. It must also allow parts to be obtained that have mechanical properties meeting all the required criteria for gold alloys intended for watchmaking.

According to the invention, this objective is achieved by a method that comprises the following steps:
a) a film of tin is applied over at least one portion of a face of a first gold alloy part;
b) the tinned face of the first gold alloy part is brought directly into contact with a face of a second gold alloy part;
c) the first and second parts are pressed against each other; and
d) the assembly is heated.

This method therefore does not require having to use a gold foil placed between the parts to be assembled.

Furthermore, this method may advantageously be implemented for assembling a multitude of parts made of different gold alloys.

The parts obtained may then be subjected to conventional treatments, such as machining operations, in order to obtain finished products.

Other features and advantages of the invention will now be described in detail in the following description given with reference to the appended drawings that show schematically:

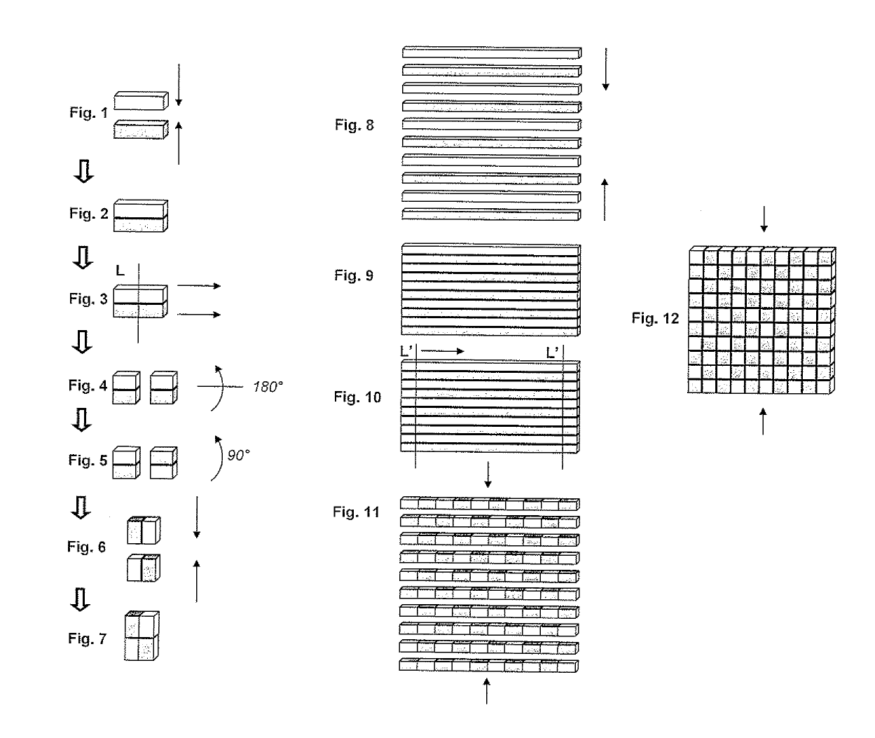

FIGS. 1 to 7: the manufacture of a checkerboard made up of four tiles by alternating two different gold alloys; and

FIGS. 8 to 12: the manufacture of a checkerboard made up of many tiles also alternating two different gold alloys.

### DETAILED DESCRIPTION OF THE INVENTION

The method according to the invention applies to all kinds of gold alloys.

As gold alloys, mention may in particular be made of 18-carat and 22-carat alloys.

As regards the colors of these alloys, these are colors present throughout the mass of the parts. They are not surface colors obtained by a heat treatment or by applying a coating.

These colors depend on the compositions of the alloys and are well known to those skilled in the art.

Thus, greenish-yellow gold, pale yellow gold, light yellow gold, yellow gold, pink gold and red gold alloys of the Au—Ag—Cu ternary system have the elemental compositions by weight and the colorimetric references according to the ISO 28654 Standards that are summarized in the table below:

| | Normalized | Elemental composition | | |
|---|---|---|---|---|
| Color | colorimetric | by weight (%) | | |
| designation | reference | Au | Ag | Cu |
| greenish- | 0 N | 58.5 | 30.0-34.0 | balance |
| yellow | | | | |
| pale yellow | 1 N | 58.5 | 24.0-26.5 | balance |
| light yellow | 2 N | 75.0 | 15.0-16.0 | balance |
| yellow | 3 N | 75.0 | 12.0-13.0 | balance |
| pink | 4 N | 75.0 | 8.5-9.5 | balance |
| red | 5 N | 75.0 | 4.5-5.5 | balance |

Gray golds are obtained by the addition of whitening elements in place of the copper and silver, such as nickel or palladium. In the case of nickel, the elemental concentration by weight of this element must be limited to 5% in order to avoid allergy problems—the alloy then remains yellowish and requires to be rhodiated. In the case of palladium, there is no longer a limitation and concentrations of 12.5% for example ensure that a quality gray gold alloy is obtained.

Golds of other colors (such as blue or purple golds) are brittle intermetallics not used for technical applications.

The first step of the method according to the invention consists in applying a film of tin over at least one portion of at least one face of a first gold alloy part.

The application may be carried out by tin electroplating, for example using an acid bath of the stannous type or an alkaline bath of the stannic type.

The tin film applied may have a thickness ranging from 0.5 to 4 microns, preferably from 1 to 2 microns.

Next, the tinned face, that is to say the one coated with tin, of the first gold alloy part is then brought into contact with and pressed against the second gold alloy part, as may be seen in FIG. 1.

The two faces in contact with each other must have, where appropriate, after tinning, a roughness of generally between 0.05 and 0.3 microns, preferably between 0.1 and 0.2 microns.

The pressure is at least 10 MPa, preferably from 50 to 100 MPa.

The parts under pressure, held in contact with each other by means of a suitable device, are placed in a furnace having a protective atmosphere, for example a nitrogen atmosphere. The furnace is generally heated to a temperature of 400 to 500° C., generally 450° C.

As regards the treatment time, this is calculated so that the state of diffusion of the various species is the same as when the part is held at 450° C. for a suitable time. This 450° C. time is called the “equivalent time”. Now, the geometry of the parts (see (1) below), their number and the installation used have an influence on the treatment time through the rate of heating. It is therefore essential to use the equivalent time to guarantee reproducibility of the bonding treatment. In addition, the equivalent time depends on the nature of the alloys chosen (see (2) below).

(1) Geometry of the Parts:

Because of the thermal inertia of the parts and the heat exchange between the furnace and the parts, the hold time for the parts cannot be the same if their geometry changes. For example, a cubic assembly of 30 cm³ volume will take around 1.5 times longer to reach the temperature of 450° C. from room temperature than a cubic assembly of 10 cm³.

(2) Composition of the Alloys:

For example, when one of the parts is a yellow gold alloy and the other is a red gold alloy, the equivalent time is between 2 and 6 hours, preferably about 4 hours.

After cooling, a strong assembly illustrated in FIG. 2 is obtained.

The method according to the invention may be implemented for assembling a plurality of parts having several different colors.

For example, the method may be used to assemble a series of first parts made of a first gold alloy with a series of second parts made of a second gold alloy.

It therefore suffices to carry out the method according to the invention, as described above, several times in order to obtain an assembly such as the one shown in FIG. 9. This may in fact be carried out repetitively, that is to say by assembling, in succession, the faces pairwise, or simultaneously, that is to say by assembling all the parts in a single operation.

In other words, to assemble a plurality of parts made of a first gold alloy and parts made of a second gold alloy, the method may be carried out as follows:
in step a) the tin film is applied over at least one portion of at least one face of each part made of a first gold alloy;
in step b), each part made of a first gold alloy is brought into contact with one or more parts made of a second gold alloy, and vice versa, and the contacting takes place between a tinned face of a part made of a first alloy and a face of a part made of a second alloy; and
in step c), each part made of a first gold alloy is pressed against at least one part made of a second gold alloy, and vice versa.

Complementary Aspects of the Method According to the Invention

The method described above may be implemented with parts of any general shape provided that they each have at least one face, whether plane or not, allowing assembly. This is because it suffices for there to be two faces that can come into contact with each other in order for assembly to be possible.

The method may be used in particular to assemble bars of rectangular, or even square, cross section.

It may also be used to assemble a cylindrical part inside another, hollow cylindrical part.

Once assembled, the parts may undergo all kinds of operations, such as machining operations.

Thus, the method may be used to join two bars of different colors, visible in FIG. 1, so as to end up with the assembly shown in FIG. 2.

The method may then be complemented with other steps in order to obtain a checkerboard comprising four tiles having alternating colors. The method then involves the following steps, as illustrated in FIGS. 3 to 6:
e) the assembly obtained in step d) shown in FIG. 2 is cut along a line L substantially perpendicular to the faces of the first and second parts that are in contact with each other;
f) one of the cuts is turned through 180° relative to the other;
g) optionally, the cuts are turned through 90° in the same direction; and
h) steps a) to d) are carried out once again.

In this way, the checkerboard comprising four tiles of alternating colors shown in FIG. 7 is obtained.

Step g) is optional and carried out only if the machine for compressing the parts is capable of operating only along a single axis.

If several bars of rectangular (or square) cross section, which may be seen in FIG. 8, are assembled in order to obtain the assembly shown in FIG. 9, the checkerboard composed of many tiles of alternating colors, shown in FIG. 12, may then be produced.

To do this, the starting point is the assembly made up of several parts shown in FIG. 9 and then the following steps, as shown in FIGS. 10 to 11, are carried out:
i) the assembly obtained in step d) shown in FIG. 9 is cut several times along lines L′ substantially perpendicular to the faces of the parts made of a first gold alloy and of the parts made of a second gold alloy that are in contact with each other;
j) one cut in two is turned through 180° relative to an adjacent cut;
k) optionally, all the cuts are turned through 90° in the same direction; and
l) steps a) to d) are carried out once again.

In this way, the checkerboard made up of many tiles of alternating colors, as shown in FIG. 12, is obtained.

Here too, step k) is optional and carried out only if the machine for compressing the parts is capable only of operating along a single axis.

The product obtained after step d), h) or 1) may then be subjected to various treatments or machining operations.

### Example

The method according to the invention was implemented for producing a checkerboard like the one shown in FIG. 12, i.e. composed of 100 tiles having alternating colors. It was made from 5 bars of a gold alloy of type (1) and 5 bars of a gold alloy of type (2), the surfaces of which that are to be assembled were ground so as to ensure an average roughness of 0.15 microns. The gold alloys to be assembled were:
type (1): an 18-carat 2N yellow gold alloy having the following composition by weight:
Au: 75%
Ag: 15.5%
Cu: the balance to 100%;
type (2): an 18-carat 5N red gold alloy having the following composition by weight:
Au: 75%
Ag: 5%
Cu: the balance to 100%.

The bars were 5 mm in height, 11 mm in thickness and 50 mm in length.

The thickness of tin applied to the yellow gold alloy was 4±0.5 microns.

After the bars had been brought into contact with each other and pressed together under 75 MPa and heated at 450° C. for 4 hours, the assembly shown in FIG. 9 was obtained.

Next, after many cutting operations, surface grinding to guarantee an average roughness of 0.15 microns, application of tin to the bars (except for the last one), followed by inverting one bar in two, rotation through 90°, recontacting, compression and heating at 450° C. for 4 hours (equivalent time), the plate shown in FIG. 12 having a height of 50 mm (10 tiles), a thickness of 11 mm and a length of 50 mm (10 tiles) was obtained.

It was found, on the one hand, that the joints were invisible to the naked eye and, on the other hand, that they did not affect the colors of the zones neighboring them.

1. A method of assembling gold alloy parts, comprising the following steps:
a) a film of tin is applied over at least one portion of a face of a first gold alloy part;
b) the tinned face of the first gold alloy part is brought directly into contact with a face of a second gold alloy part;
c) the first and second parts are pressed against each other; and
d) the assembly is heated.

2. The method as claimed in claim 1, in which the pressure applied in step c) is at least 10 MPa, preferably from 50 to 100 MPa.

3. The method as claimed in claim 1, in which the faces brought into contact with each other have a roughness of between 0.05 and 0.3 microns, preferably between 0.1 and 0.2 microns.

4. The method as claimed in claim 1, in which the tin film applied in step a) has a thickness ranging from 0.5 to 4 microns, preferably from 1 to 2 microns.

5. The method as claimed in claim 1, in which the first and second parts are made of different gold alloys.

6. The method as claimed in claim 5, in which the first and second parts are made of gold alloys having different colors.

7. The method as claimed in claim 1, in which the first part is made of a yellow gold alloy and the second part is made of a red gold alloy, and the parts are heated for 2 to 6 hours.

8. The method as claimed in claim 7, in which the parts are heated for 4 hours.

9. Method in which a plurality of parts made of a first gold alloy and parts made of a second gold alloy are assembled, the first and second alloys having different colors, by implementing the method as claimed in claim 1 several times, either in succession or simultaneously, and in which:
in step a) the tin film is applied over at least one portion of at least one face of each part made of a first gold alloy;
in step b), each part made of a first gold alloy is brought into contact with one or more parts made of a second gold alloy, and vice versa, and the contacting takes place between a tinned face of a part made of a first gold alloy and a face of a part made of a second gold alloy; and
in step c), each part made of a first gold alloy is pressed against at least one part made of a second gold alloy, and vice versa.

10. The method as claimed in claim 1, which further includes the following steps:
e) the assembly obtained in step d) is cut along a line perpendicular to the faces of the first and second parts that are in contact with each other;
f) one of the cuts is turned through 180° relative to the other;
g) optionally, the cuts are turned through 90° in the same direction; and
h) steps a) to d) are carried out once again.

11. The method as claimed in claim 9, which further includes the following steps:
i) the assembly obtained in step d) is cut several times along lines perpendicular to the faces of the parts made of a first gold alloy and of the parts made of a second gold alloy that are in contact with each other;
j) one cut in two is turned through 180° relative to an adjacent cut;
k) optionally, all the cuts are turned through 90° in the same direction; and
l) steps a) to d) are carried out once again.

12. The method as claimed in claim 1, in which the parts are bars of rectangular cross section.
